(19) United States
(12) Patent Application Publication
(10) Pub. No.: US 2016/0061984 A1
(43) Pub. Date: Mar. 3, 2016

(54) AUTONOMOUS VEHICLE FOR AIRBORNE ELECTROMAGNETIC SURVEYING

(71) Applicant: CGG DATA SERVICES AG, Zug (CH)

(72) Inventor: Richard Thomas PARTNER, Kemptville, Ontario (CA)

(21) Appl. No.: 14/787,346

(22) PCT Filed: Apr. 29, 2014
(86) PCT No.: PCT/CA2014/050405

§ 371 Date: Oct. 27, 2015

Related U.S. Application Data
(60) Provisional application No. 61/817,346, filed on Apr. 30, 2013.

(51) Int. Cl. G01V 3/16; G05D 1/00; G01V 3/10

(52) U.S. Cl. CPC G01V 3/16; G01V 3/10; G05D 1/0088

(57) ABSTRACT

The present invention provides an airborne electromagnetic survey system having one or more autonomous vehicles comprising one or more active flight control members and housing at least one of a receiver, a transmitter, and other measuring device. The airborne electromagnetic survey system may include a controller that enables dynamic adjustment of the location and/or the orientation of the vehicle relative to other components of the EM system. The controller estimates, based on at least one of operational and environmental data of the survey during flight, the optimal location of said vehicle relative to other components of the EM system.

### TECHNICAL FIELD OF THE INVENTION

The present invention relates to electromagnetic systems, and more particularly to systems and methods for conducting geophysical surveys using an autonomous vehicle comprising at least one selected from the group consisting of a receiver, a transmitter and other sensor means.

### BACKGROUND OF THE INVENTION

Electromagnetic (EM) measurement systems for geophysical measurement purposes detect the electric and magnetic fields that can be measured in, on or above the earth, to identify subsurface changes in electrical properties of materials beneath the earth's surface. Airborne EM systems carry out the field measurements in the air above the earth. A primary goal is to make measurements at a number of spatial locations to identify the size and position of localized material property changes. Such changes can be attributed to a desired outcome such as identifying a localized mineral deposit, a buried object, or the presence or absence of water.

Generally speaking, active airborne EM systems usually include a source of electromagnetic energy or transmitter and a receiver to detect the response of the ground. The transmitter generates a primary electromagnetic field which induces electrical currents in the ground, and the secondary electromagnetic field produced by these currents is measured to provide information regarding ground conductivity distributions. By processing and interpreting the received signals, it is possible to make deductions about the distribution of anomalous conductivity in the subsurface.

EM measurements can be made in either frequency domain or time domain. In a frequency domain EM system, the transmitter generates an electromagnetic field at a range of excitation frequencies. In a time domain EM system, transient pulses are generated by the transmitter to create a primary electromagnetic field that induces a decaying secondary electromagnetic field. The receiver measures the amplitude and decay characteristics of the secondary field. Passive airborne EM systems rely on natural sources such as lightening or magnetosphere activity to induce electrical currents and resulting electromagnetic fields in the ground which are then measured by the receiver. In such systems, there is no transmitter, however all other aspects are similar to active airborne EM systems.

The existing prior art EM systems are typically provided with a predetermined configuration or geometrical arrangement between the various components thereof which remains substantially unchanged during a survey flight. Due to this lack of flexibility, prior art EM systems generally are not well equipped to transmit or take receiver measurements at optimal locations. As a result, it can be challenging to further optimize the performance of the prior art EM systems.

Therefore, there remains a need for an improved EM surveying system.

### SUMMARY OF THE INVENTION

The present invention overcomes the above drawbacks of the prior art EM systems by providing an EM system that allows dynamic adjustment of the location and/or the orientation of the receiver and/or transmitter relative to other components of the EM system and/or terrain.

The present invention improves the overall performance of the EM system by controlling or piloting the receiver and/or transmitter during flight to optimize the geometric configuration, preferably as a function of survey operation and/or environment information, and therefore provides advantage in discriminating geology of interest.

In accordance with one aspect of the present invention, there is provided an airborne electromagnetic survey system, comprising at least one of: a transmitter for generating a primary electromagnetic field that induces a secondary electromagnetic field; a receiver for detecting the secondary electromagnetic field; a receiver for detecting natural source electromagnetic field; and an autonomous vehicle that comprises one or more active flight control members and housing at least one of a receiver, a transmitter and other measuring device.

In accordance with another aspect of the present invention, there is provided an airborne electromagnetic survey system, comprising at least one of: a transmitter for generating a primary electromagnetic field that induces a secondary electromagnetic field; a receiver for detecting said secondary electromagnetic field; a receiver for detecting natural source electromagnetic field; an autonomous vehicle that comprises one or more active flight control members and housing at least one of a receiver, a transmitter and other measuring device; and a controller for controlling a location of said autonomous vehicle based on at least one of operational and environmental data of said survey during flight.

In accordance with another aspect of the present invention, there is provided a method of conducting an airborne geological survey, comprising at least one of: providing one or more transmitters for generating a primary electromagnetic field that induces a secondary electromagnetic field; providing one or more receivers for detecting said secondary electromagnetic field; providing one or more receivers for detecting natural source electromagnetic field; providing an autonomous vehicle that comprises one or more active flight control members and housing at least one of a receiver, a transmitter and other measuring device, and controlling a location of said autonomous vehicle based on at least one of operational and environmental data of said survey during flight.

In accordance with another aspect of the present invention, there is provided a system for controlling an electromagnetic system for conducting an airborne survey, comprising: means for estimating, based on at least one of operational and environmental data of said survey during flight, an optimal location of an autonomous vehicle, housing at least one of a receiver, a transmitter, and other measuring device of said electromagnetic system, relative to said electromagnetic system; and means for moving said autonomous vehicle to said estimated optimal location.

In accordance with another aspect of the present invention, there is provided a method of controlling an electromagnetic system for conducting an airborne survey, comprising: estimating, based on at least one of operational and environmental data of said survey during flight, optimal location of an autonomous vehicle, and housing at least one of a receiver, a transmitter, and other measuring device of said electromagnetic system relative to said electromagnetic system; and moving said receiver to said estimated optimal location.

Other features and advantages of the present invention will become apparent from the following detailed description and the accompanying drawings, which illustrate, by way of example, the principles of the invention.

### BRIEF DESCRIPTION OF THE DRAWINGS

By way of examples only, preferred embodiments of the present invention are described hereinafter with reference to the accompanying drawings, wherein:

FIG. 1 is a block diagram of an illustrative embodiment of an airborne EM survey system;

FIG. 2 is a schematic perspective view of an embodiment of an airborne EM survey system with an active EM transmitter thereof supported on an aircraft in an airborne position flying at surveying speeds and a towed autonomous vehicle that comprises an EM receiver;

FIG. 3 is a schematic perspective view of an embodiment of an airborne EM survey system with an aircraft in an airborne position flying at surveying speeds and a towed autonomous vehicle that comprises an EM receiver and a second towed autonomous vehicle that comprises an active EM transmitter;

FIG. 4 is a schematic perspective view of an embodiment of an airborne EM survey system with an aircraft in an airborne position flying at surveying speeds and a towed autonomous vehicle that comprises an EM receiver for detecting natural source EM fields;

FIG. 5 is a schematic perspective view of an embodiment of an autonomous vehicle which comprises one or more active flight control members, and housing at least one selected from a group consisting of a receiver, a transmitter and other measuring device;

FIG. 6 is a schematic partial cutaway view of an embodiment of an autonomous vehicle which comprises one or more active flight control members, and housing a receiver;

### DETAILED DESCRIPTION OF THE INVENTION

The present invention will now be described with reference to the accompanying drawings, in which some, but not all embodiments of the invention are shown.

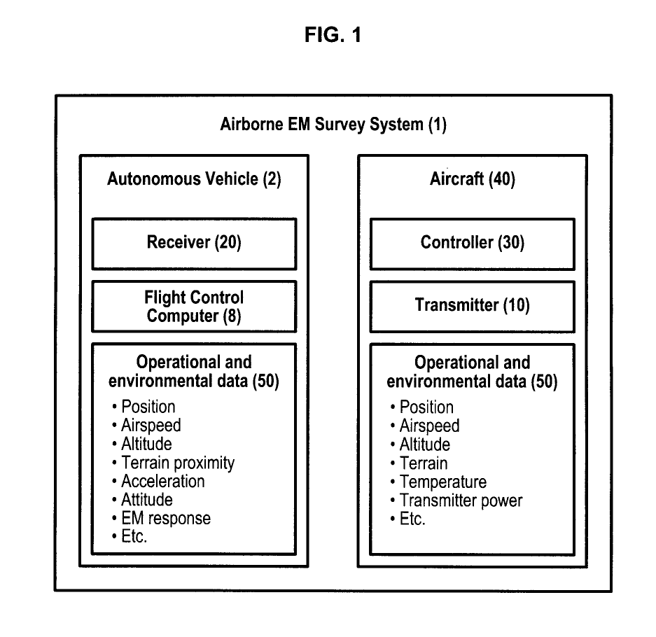

The present invention may be implemented as an airborne EM survey system such as the one shown using block diagrams in FIG. 1.

Referring to the block diagram shown in FIG. 1, and in accordance with some example embodiments of the present disclosure, there is provided an airborne EM survey system 1 comprising an aircraft 40; an autonomous vehicle 2; and at least one of a transmitter 10 for generating a primary electromagnetic field that induces a secondary EM field; an EM receiver 20 for detecting the secondary electromagnetic field; an EM receiver 20 for detecting natural source EM fields; and a controller 30 for controlling a location and/or orientation of said receiver 20, based on at least one of operational and environmental data 50 of the EM survey system during flight.

The aircraft 40 can be manned or unmanned power driven fixed-wing airplane, helicopter, airship or any other flying machine.

Operational data of the airborne EM survey system 1 may comprise various operating parameters and values characterizing the configuration of the airborne EM survey system 1 and/or components thereof, as well as data associated with various attributes of the airborne EM survey system 1 during survey, such as position, airspeed, altitude, terrain proximity, acceleration, attitude and the like. Other data, such as EM field measurements, may also be included in operational data of the EM survey system.

Environmental data generally include data indicative of the environment in which the EM system operates, and may include information about geology, terrain, weather conditions, geomagnetic conditions, atmospheric conditions and the like.

Still referring to FIG. 1, the controller 30 is in direct or indirect communication with the autonomous vehicle 2 and can be located anywhere within the EM survey system. In addition, the controller 30 may comprise subcomponents that can be located anywhere within the airborne EM survey system 1 or distributed in any suitable manner therein.

In some embodiments, the transmitter 10 can be installed within the autonomous vehicle 2.

In some embodiments, the receiver 20 can be installed within the autonomous vehicle 2.

In some embodiments, the controller 30 can be installed within the autonomous vehicle 2.

In an embodiment wherein the airborne EM survey system 1 comprises multiple autonomous vehicles 2, there may be multiple controllers 30.

In some example embodiments, the controller 30 described herein comprises a computer or processor or means for processing input data including the operational data of the EM survey system during flight and/or the data relating to the environment within which the survey is conducted. In particular, based on the operational and/or the environmental data, the processor estimates an optimal location and/or orientation of the transmitter 10 and/or the receiver 20 for measuring the ground response or avoiding obstacles such as terrain or other components of the EM system.

Preferably, the controller 30 or the processor thereof implements program instructions for estimating the ideal location of the transmitter 10 and/or the receiver 20 as a function of the operational and/or environmental data of a survey during flight.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function described herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions described herein.

In some embodiments, as exemplified in FIG. 1, the autonomous vehicle 2 comprises a flight control computer 8 implementing a flight guidance algorithm for controlling the flight of the autonomous vehicle 2.

It is important to note that the controller 30 and any components thereof such as the flight control computer 8 can be installed anywhere within the EM survey system. For example, in some embodiments, the flight control computer 8 can be installed in the towing aircraft, with a communication link such as telemetry link to the autonomous vehicle 2 to enable control thereof. In some embodiments, the flight control computer 8 may be provided within the autonomous vehicle 2.

In some example embodiments, the controller 30 described herein comprises actuating means such as an actuator for enabling movement of one or more of the flight control members 3 to position the autonomous vehicle 2 relative to the airborne EM survey system 1, transmitter(s) 10, receivers 20, and/or any other component of the airborne EM survey system 1.

In some example embodiments, the actuator is in communication with the processor of the controller 30 or the flight control computer 8 thereof, and in response to control commands from the controller 30 or the flight control computer 8, apply necessary forces or energy to portions of the autonomous vehicle 2 to move to a desired location and/or assume a desired orientation as indicated in the control commands.

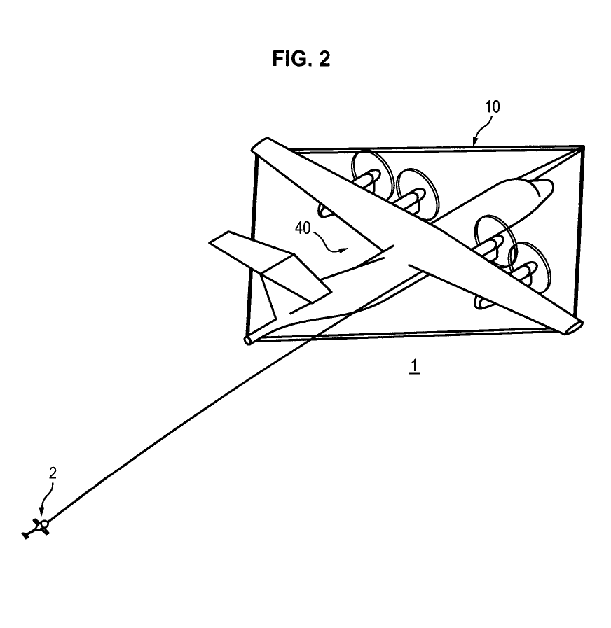

Referring to FIG. 2, one embodiment of the airborne EM survey system 1 comprises an EM transmitter 10 and a towed autonomous vehicle 2 that comprises an EM receiver 20.

Referring to FIG. 2, the construction and operation of the transmitter 10 and the associated transmitter coils can be provided in accordance with conventional EM practice. For example, the transmitter 10 may comprise a transmitter loop frame which supports a transmitter loop coil for generating a primary electromagnetic field that induces a secondary electromagnetic field in the ground.

In the embodiments shown in FIG. 2, the transmitter 10 is supported on the aircraft or in proximity thereto. However, a person skilled in the art would appreciate that the transmitter 10 can be supported in any other suitable manner. While FIG. 2 shows a towed autonomous vehicle 2 comprising an EM receiver 20, other configurations of the receiver(s) are also possible.

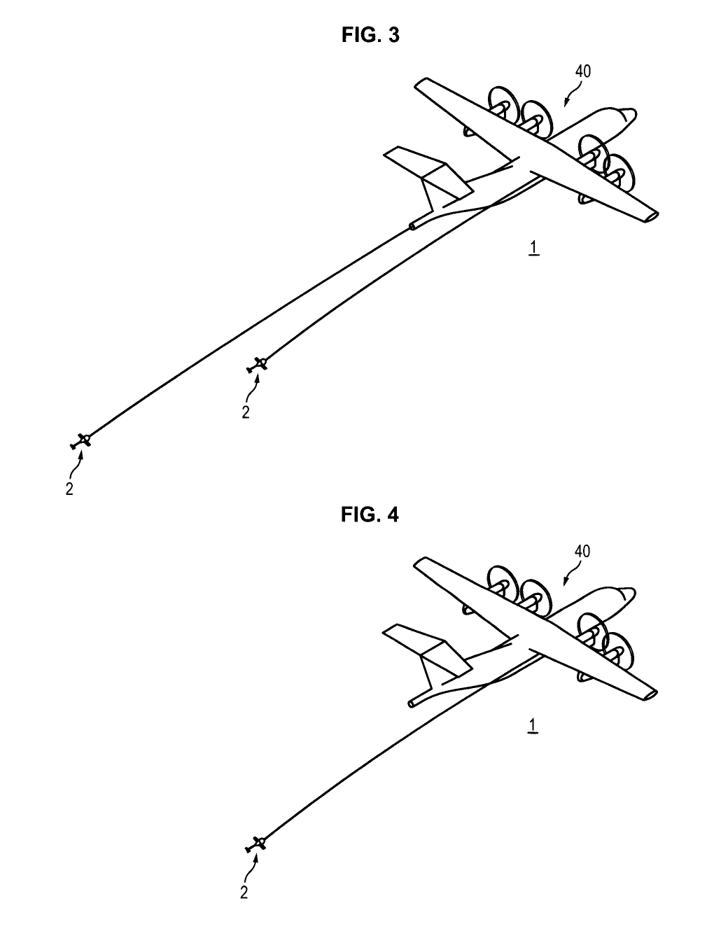

Referring to FIG. 3, another embodiment of the airborne EM survey system 1 comprises a towed autonomous vehicle 2 that comprises an EM receiver 20 and a second towed autonomous vehicle 2 that comprises an EM transmitter 10. In some embodiments, the EM system 1 comprises multiple transmitters 10 and/or multiple receivers 20.

Referring to FIG. 4, another embodiment of the airborne EM survey system 1 comprises a towed autonomous vehicle 2 that comprises an EM receiver 20 for detecting natural source EM fields. In some embodiments, the EM system 1 comprises multiple receivers 20 for detecting natural source EM fields.

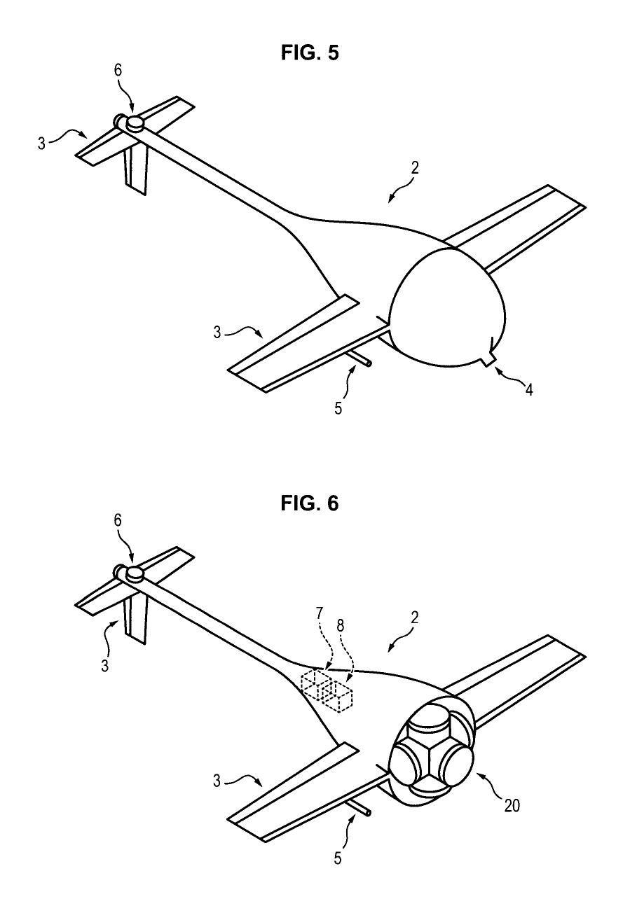

Referring to FIG. 5, there is shown an autonomous vehicle 2 comprising at least one flight control member 3 for directing the movement of the autonomous vehicle 2.

Referring to FIG. 6, there is shown an autonomous vehicle 2 comprising at least one flight control member 3 for directing the movement of the autonomous vehicle 2 and an EM receiver 20. A person skilled in the art would appreciate the autonomous vehicle 2 might also include one or more of an EM transmitter, passive EM receiver, and other sensor relevant to the EM system 1.

Referring to FIGS. 5 and 6, in some preferred embodiments, the autonomous vehicle 2 comprises one or more sensors such as a terrain proximity sensor 4, airspeed and barometric sensor 5, Global Positioning Sensor (GPS) 6 or Global Navigation Satellite System (GNSS) receiver, inertial measuring unit (IMU) 7, and other physical or environmental sensors.

In some embodiments, at least one of the flight control members 3 are coupled to the receiver 20 and extending therefrom, and is preferably constructed from materials suitable for airborne use.

Preferably, the flight control members 3 are provided in such a manner that they are operable to be coupled to the actuator of the controller 30 to allow the autonomous vehicle 2 to move in any desirable direction/orientation within the operating freedom or clearance of the autonomous vehicle 2, as designed to operate within the airborne EM survey system 1. For example, when actuated, one or more of the flight control members 3 as shown in FIGS. 5 and 6 may move to steer the autonomous vehicle 2 in lateral and/or vertical directions, or rotate in pitch, roll and/or yaw.

In some example embodiments, as those shown in FIGS. 5 and 6, the autonomous vehicle 2 is constructed in a form that is optimized for providing enhanced aerodynamics to reduce wind drag and thereby increase fuel efficiency of the aircraft. For example, the autonomous vehicle 2 can be modeled and built similar to a flying machine or apparatus.

In some embodiments, the autonomous vehicle 2 may comprise fuselage and wing-like flight control members 3, wherein flight control members 3 may comprise for example, at least one of wings, slats, winglets, spoilers, ailerons, flaps, horizontal stabilizers, elevators, vertical stabilizers, rudders, buoyancy compensation, and any other equivalent or substitution of the above.

Preferably, the flight control members 3 comprise active flight control portions or surfaces provided in such a manner that when actuated, may enable changes in lift, drag, pitch, roll, yaw, buoyancy, and/or any combination thereof in the autonomous vehicle 2.

In some example embodiments, the autonomous vehicle 2 may comprise an engine or motor that is independent from that of the aircraft, for powering the airborne operation of the receiver 20 or transmitter 10 in cooperation with the EM survey system 1, including driving the autonomous vehicle 2 during survey flight.

Advantageously, an independent engine provides more accurate control of the position and/or orientation of the autonomous vehicle 2 when compared to a towed receiver or transmitter that does not have its own engine.

In some example embodiments, the autonomous vehicle 2 can be independent or un-tethered or unconnected from the airborne EM survey system 1 and have its own means of propulsion. For example, the autonomous vehicle 2 need not be towed by a surveying aircraft. In such embodiments, the autonomous vehicle 2 may be controlled by the controller 30 to fly independently from but in cooperation with the aircraft supporting the airborne EM survey system 1. Although untethered, the autonomous vehicle 2 may be in communication with the airborne EM survey system 1 so as to relay the ground response induced by the transmitter 10, the ground response induced by natural EM sources, or any other sensor information relevant to the controller 30.

In some example embodiments, the autonomous vehicle 2 having independently means of propulsion can be towed by an aircraft in any manner known in the art. However, in such embodiments, the autonomous vehicle 2 will be able to move independently using its own propulsion means such as engine or motor, subject to any applicable constraints from the towing means such as tow ropes or cables. In other words, the towed autonomous vehicle 2 is substantially free to move or rotate within a radius defined by the maximum allowable distance between the autonomous vehicle 2 and the aircraft. As a result, during a survey flight, the autonomous vehicle 2 may change or adjust its position/orientation/configuration, relative to one or more of the aircraft, the airborne EM survey system 1, the transmitter(s) 10, the receiver(s) 20, and any other components of the airborne EM survey system 1.

In embodiments where the autonomous vehicle 2 is towed by an aircraft, the distance or offset between the autonomous vehicle 2 and the towing aircraft is preferably configurable. For example, the maximum distance between the towing aircraft and the towed autonomous vehicle 2 can be dynamically selected in accordance with the particulars of the survey in question.

Advantageously, the EM survey system comprising an independent autonomous vehicle 2 reduces the restriction on the flying routes for the autonomous vehicle 2, thereby allowing the autonomous vehicle 2 increased freedom to move to a position that is more optimal for transmitting or detecting ground response when comparing with prior art EM system wherein the transmitter and receiver are restricted to substantially follow the flying routes of the towing aircraft.

The controller 30 and flight control computer 8 may comprise one or more sensors for collecting data relating to the local environment in which the airborne survey is conducted and data relating to the operation of the EM survey system during flight.

Terrain proximity data can be used by the flight control computer 8 to implement terrain avoidance in the steering algorithm to prevent the autonomous vehicle 2 from involving in terrain related flight accidents, thereby protecting the surveying equipment. In addition, terrain data obtained from the terrain proximity sensor 4 can be used by the controller 30, independently or in combination with local environment data and operational data, to estimate an optimal position and/or orientation of the autonomous vehicle 2 to increase the performance of the EM survey system.

In various example embodiments, the airborne EM survey system 1 or the controller 30 may comprise one or more sensors of other types installed at various suitable locations within the EM survey system such as barometric sensor, wind sensor, weather sensor, lightning sensor and other similar sensing devices.

In some example embodiments, the airborne EM survey system 1 or the controller 30 may comprise one or more sensors for collecting data relating to the operation of the EM survey system. For example, operational data sensors may include airspeed and barometric sensor 5 and inertial measuring unit 7.

The data collected by the various sensors can be used by the controller 30, independently or in combination with other local environment data and operational data, to estimate an optimal position and/or orientation of the autonomous vehicle 2 or the transmitter 10 or the receiver 20 to provide improved survey results or increase the performance of the airborne EM survey system 1.

Advantageously, the example embodiments of the present disclosure provide an airborne EM survey system 1 that allows dynamic adjustment of the location and/or the orientation of at least one of its subsystems such as the receiver 20 and/or transmitter 10 relative to other components of the airborne EM survey system 1.

The embodiments described herein improve the overall performance of the airborne EM survey system 1 by controlling or steering the receiver 20 and/or transmitter 10, preferably as a function of survey operation and/or environment information, and therefore provides advantage in discriminating geology of interest.

Although the present invention has been described in considerable detail with reference to certain preferred embodiments thereof, other embodiments and modifications are possible. Therefore, the scope of the appended claims should not be limited by the preferred embodiments set forth in the examples, but should be given the broadest interpretation consistent with the description as a whole.

1-14. (canceled)

15. An airborne electromagnetic survey system, comprising:
a transmitter to generate a primary electromagnetic field that induces a secondary electromagnetic field;
a first receiver to detect the secondary electromagnetic field;
a second receiver to detect a natural source electromagnetic field; and
an autonomous vehicle that houses at least one of the transmitter, the first receiver or the second receiver,
wherein the autonomous vehicle has a fly control member with which the autonomous vehicle adjusts its position relative to an aircraft during the survey.

16. The system of claim 15, wherein the first and second receivers comprise at least one receiver coil.

17. The system of claim 15, wherein the autonomous vehicle comprises at least one of a terrain proximity sensor, a GPS or GNSS receiver, an inertial measuring unit, a barometric sensor, and an airspeed sensor.

18. The system of claim 15, wherein the autonomous vehicle is independent or un-tethered and has its own propulsion system.

19. The system of claim 15, further comprising the aircraft.

20. The system of claim 19, wherein the transmitter is located on the aircraft and the first receiver is located on the autonomous vehicle.

21. The system of claim 19, wherein the autonomous vehicle is configured to independently move relative to the aircraft.

22. The system of claim 19, wherein the autonomous vehicle is tethered to the aircraft and configured to independently move relative to the aircraft within a radius defined by a maximum allowable distance between the autonomous vehicle and the aircraft.

23. The system of claim 19, further comprising another autonomous vehicle and both the autonomous vehicle and the another autonomous vehicle are tethered to the aircraft.

24. The system of claim 15, further comprising:
a controller that controls a location of the autonomous vehicle based on at least one of operational and environmental data of the survey during flight.

25. The system of claim 15, wherein the autonomous vehicle comprises:
additional flight control members that adjust a trajectory of the autonomous vehicle during the survey.

26. The system of claim 25, wherein the flight control members rotate the autonomous vehicle.

27. The system of claim 15, wherein a position of at least one of the transmitter, first receiver and the second receiver is adjusted during the survey relative to the others of the transmitter, first receiver and the second receiver.

28. A method of conducting an airborne geological survey, comprising:
flying a transmitter to generate a primary electromagnetic field that induces a secondary electromagnetic field;
flying a first receiver to detect the secondary electromagnetic field;
flying a second receiver to detect a natural source electromagnetic field; and
driving an autonomous vehicle that comprises at least one of the transmitter, first receiver and second receiver.

29. The method of claim 28, further comprising:
controlling a location of the autonomous vehicle based on at least one of operational and environmental data of the survey during flight.

30. The method of claim 28, further comprising:
tethering the autonomous vehicle to an aircraft; and
distributing some of the transmitter, first receiver and the second receiver on the autonomous vehicle and the others on the aircraft.

31. The method of claim 30, further comprising:
independently controlling a position of the autonomous vehicle relative to the aircraft within a radius defined by a maximum allowable distance between the autonomous vehicle and the aircraft.

32. The method of claim 30, further comprising:
locating the transmitter on the aircraft; and
locating the first and second receivers on the autonomous vehicle.

33. An airborne electromagnetic survey system, comprising:
a transmitter to generate a primary electromagnetic field that induces a secondary electromagnetic field;
a receiver to detect the secondary electromagnetic field;
an aircraft; and
an autonomous vehicle flying behind the aircraft and configured to house at least one of the transmitter or the receiver.

34. The system of claim 33, wherein the aircraft houses the transmitter and the autonomous vehicle houses the receiver.
